(19) United States
(12) Patent Application Publication
(10) Pub. No.: US 2025/0046494 A1
(43) Pub. Date: Feb. 6, 2025

(54) HEAT-RESISTANT ELECTRIC WIRE

(71) Applicant: SUMITOMO ELECTRIC INDUSTRIES, LTD., Osaka (JP)

(72) Inventor: Nanae FUJIOKA, Tochigi (JP)

(73) Assignee: SUMITOMO ELECTRIC INDUSTRIES, LTD., Osaka (JP)

(21) Appl. No.: 18/773,649

(22) Filed: Jul. 16, 2024

(30) Foreign Application Priority Data
Jul. 31, 2023 (JP) 2023-124761

(51) Int. Cl. H01B 7/29; H01B 3/30

(52) U.S. Cl. CPC H01B 7/292; H01B 3/30

(57) ABSTRACT

A heat-resistant electric wire of the present disclosure includes a conductor, and an insulator configured to cover the conductor. A ratio of an outer diameter of the conductor to an outer diameter of the insulator is 0.45 to 0.55. The conductor is a compressed conductor in which a stranded wire including a plurality of conductor element wires is compressed, the plurality of conductor element wires being twisted together. The insulator contains one or more types of resin materials selected from a fluororesin and a fluororubber and includes a cavity. Porosity of the insulator is 10% to 60%.

### CROSS REFERENCE TO RELATED APPLICATIONS

This application claims priority based on Japanese Patent Application No. 2023-124761 filed on Jul. 31, 2023, and the entire contents of the Japanese patent application are incorporated herein by reference.

### TECHNICAL FIELD

The present disclosure relates to a heat-resistant electric wire.

### BACKGROUND

Patent literature (Japanese Unexamined Patent Application Publication No. 2021-106131) discloses an electrically insulated cable using crosslinked fluororubber for the insulating layer.

### SUMMARY

The purpose of the present disclosure is to provide a heat-resistant electric wire having excellent characteristics as an electric wire while reducing the amount of a fluorine-containing resin used.

A heat-resistant electric wire of the present disclosure includes a conductor, and an insulator configured to cover the conductor. A ratio of an outer diameter of the conductor to an outer diameter of the insulator is 0.45 to 0.55. The conductor is a compressed conductor in which a stranded wire including a plurality of conductor element wires is compressed, the plurality of conductor element wires being twisted together. The insulator contains one or more types of resin materials selected from a fluororesin and a fluororubber and includes a cavity. Porosity of the insulator is 10% to 60%.

### BRIEF DESCRIPTION OF THE DRAWINGS

FIG. 1 is a cross-sectional view of a heat-resistant electric wire in a plane perpendicular to a longitudinal direction according to an embodiment of the present disclosure.

FIG. 2A is an explanatory view of Dmax used for calculating porosity.

FIG. 2B is an explanatory view of Dmin used for calculating porosity.

FIG. 3 is a partial perspective view of an extruder that can be used in manufacturing a heat-resistant electric wire according to an embodiment of the present disclosure.

FIG. 4 is a cross-sectional view of a heat-resistant electric wire produced in Example 2, taken along a plane perpendicular to a longitudinal direction.

### DETAILED DESCRIPTION

For the purpose of improving heat resistance and the like, an electric wire using a fluorine-containing resin such as fluororubber as an insulator has been conventionally used. However, in recent years, from the viewpoint of SDGs (Sustainable Development Goals) and the like, an electric wire is required which has excellent characteristics as an electric wire in terms of voltage endurance characteristics, elongation tensile-strength, and the like, and in which the amount of the fluorine-containing resin used is reduced.

Embodiments will be described below.

### [Description of Embodiments of Present Disclosure]

First, embodiments of the present disclosure will be listed and described. In the following description, the same or corresponding elements are denoted by the same reference numerals, and the same description thereof will not be repeated.

(1) A heat-resistant electric wire according to an aspect of the present disclosure includes a conductor, and an insulator configured to cover the conductor. A ratio of an outer diameter of the conductor to an outer diameter of the insulator is 0.45 to 0.55. The conductor is a compressed conductor in which a stranded wire including a plurality of conductor element wires is compressed, the plurality of conductor element wires being twisted together. The insulator contains one or more types of resin materials selected from a fluororesin and a fluororubber and includes a cavity. Porosity of the insulator is 10% to 60%.

The insulator may contain a fluorine-containing resin, which is fluororesin or fluororubber, as a resin material. Since the insulator includes a cavity, the amount of the fluorine-containing resin used can be reduced.

By using a compressed conductor as the conductor, a size of a gap generated between the conductor element wires constituting the conductor can be reduced. Thus, the material of the insulator covering the conductor is prevented from entering between the conductor element wires constituting the conductor, and the shape of the cavity of the insulator can be formed into a desired shape. Further, the insulator can be suppressed from varying in thickness.

As a result, the heat-resistant electric wire according to an aspect of the present disclosure can satisfy the required standards for voltage endurance characteristics and elongation tensile-strength.

When the ratio of the outer diameter of the conductor to the outer diameter of the insulator is 0.55 or less, the thickness of the insulator can be sufficiently secured, and the voltage endurance characteristics and the elongation tensile-strength of the heat-resistant electric wire according to an aspect of the present disclosure can be particularly enhanced.

By setting the ratio of the outer diameter of conductor to the outer diameter of insulator to 0.45 or more, the insulator can be prevented from being excessively thick, and workability during wiring, handleability during transportation, and the like can be enhanced.

By setting the porosity of the insulator to 10% or more, the amount of the fluorine-containing resin used can be reduced. In addition, the weight of the heat-resistant electric wire can be suppressed, and the workability during wiring and the handleability during transportation can be enhanced.

When the porosity of the insulator is 60% or less, the ratio of the resin portion contained in the insulator can be increased, and the voltage endurance characteristics and the tensile-strength of the heat-resistant electric wire according to an aspect of the present disclosure can be particularly increased.

(2) In (1), the porosity of the insulator may be 40% to 60%.

By setting the porosity of the insulator to 40% to 60%, the amount of the fluorine-containing resin used can be particularly reduced, the weight of the heat-resistant electric wire can be suppressed, and the workability during wiring and the handleability during transportation can be particularly enhanced. In addition, the voltage endurance characteristics and the elongation tensile-strength of the heat-resistant electric wire according to an aspect of the present disclosure can be increased.

### [Details of Embodiments of Present Disclosure]

A specific example of a heat-resistant electric wire according to an embodiment of the present disclosure (hereinafter, referred to as “the embodiment”) will be described below with reference to the drawings. It is noted that, the present invention is not limited to these examples, but is defined by the scope of the claims, and is intended to include all modifications within the meaning and scope equivalent to the scope of the claims.

### (Heat-Resistant Electric Wire)

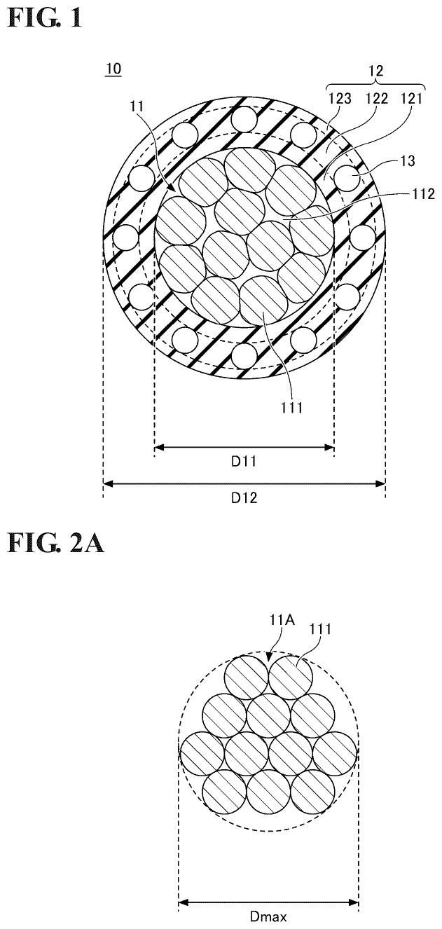

FIG. 1 shows an example of a cross-section perpendicular to a longitudinal direction of a heat-resistant electric wire of the embodiment.

As shown in FIG. 1, a heat-resistant electric wire 10 of the embodiment includes a conductor 11 and an insulator 12 covering conductor 11.

The respective members of heat-resistant electric wire 10 of the embodiment will be described below.

### (1) Conductor

### (1-1) About Materials

As shown in FIG. 1, conductor 11 may be a compressed conductor obtained by compressing a stranded wire obtained by twisting a plurality of conductor element wires 111, specifically, for example, by compressing the stranded wire from the outer periphery.

By using the compressed conductor as conductor 11, the size of a gap 112 generated between conductor element wires 111 constituting conductor 11 can be suppressed. Thus, the material of insulator 12 covering conductor 11 is prevented from entering between conductor element wires 111 constituting conductor 11, and a cavity 13 of insulator 12 can be formed into a desired shape. Further, the variation in thickness of insulator 12 can be suppressed.

As a result, heat-resistant electric wire 10 of the embodiment can satisfy the required standards for the voltage endurance characteristics and the elongation tensile-strength.

The voltage endurance characteristics refer to insulation characteristics of insulator 12 included in heat-resistant electric wire 10 of the embodiment.

The elongation tensile-strength refers to an elongation until insulator 12 of heat-resistant electric wire 10 of the embodiment fractures when pulled along the longitudinal direction at a predetermined speed.

The material of conductor element wire 111 constituting conductor 11 is not particularly limited, but one or more conductor materials selected from copper, copper alloy, silver-plated soft copper, and tin-plated soft copper can be used, for example. As the copper, soft copper can be suitably used.

### (1-2) About Compression Ratio

The compression ratio, which is the degree of compression of conductor 11, is not particularly limited, but may be set to, for example, 30% to 70%.

By setting the compression ratio of conductor 11 to 30% or more, the size of the gap generated between conductor element wires 111 constituting conductor 11 can be particularly suppressed. Thus, the shape of the cavity of insulator 12 can be particularly easily controlled to be a desired shape. Thus, the voltage endurance characteristics and the elongation tensile-strength of heat-resistant electric wire 10 can be particularly enhanced.

By setting the compression ratio of conductor 11 to 70% or less, the time required for compressing the stranded wire of conductor element wires 111 is suppressed when the compressed conductor is manufactured, and the productivity of heat-resistant electric wire 10 is increased.

In calculating a circle equivalent diameter of conductor element wire 111, first, a cross-sectional area of conductor 11 excluding gap 112 in a cross section randomly selected in conductor 11 is measured, and the number of conductor element wires included in the conductor is counted. Next, the measured cross-sectional area of conductor 11 is divided by the number of conductor element wires 111 to obtain the cross-sectional area of each conductor element wire 111. Then, a diameter of a circle having the same cross-sectional area as that of conductor element wire 111 is calculated, and the diameter of the circle is defined as the equivalent circle diameter of conductor element wire 111.

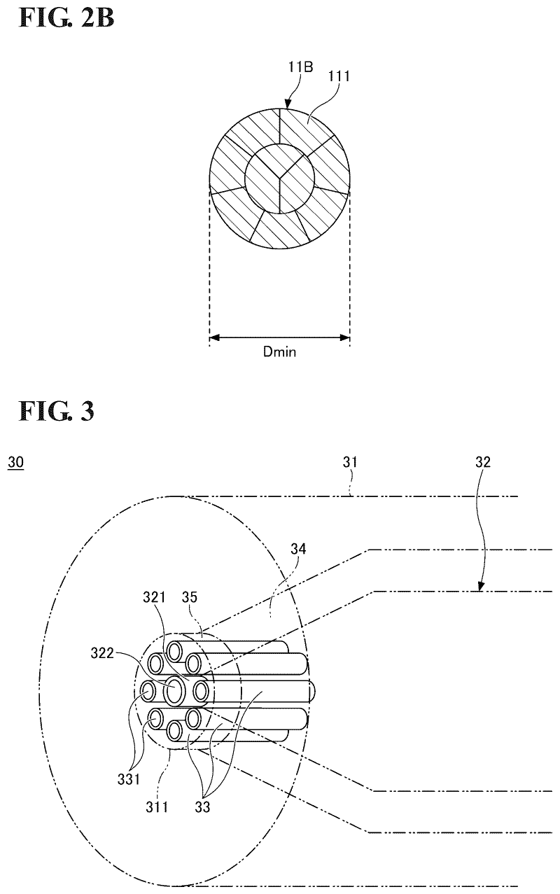

Next, as shown in FIG. 2A, a diameter of a circumscribed circle of an aggregate 11A in the case where the circles obtained above are in contact with each other and the aggregate of the circles are aggregated into a shape closest to a circle is obtained, and the obtained diameter is set as Dmax.

Next, as shown in FIG. 2B, when the compression ratio is 100%, that is, when the compression is performed so that gap 112 between conductor element wires 111 is completely eliminated, the conductor (an aggregate 11B) is assumed to be a circle, and a diameter of this circle is obtained and is set as Dmin.

Then, the compression ratio R can be calculated by the following formula (1) from an outer diameter D11 of conductor 11 for obtaining the compression ratio.

$$R = ( Dmax - D 11 ) / ( Dmax - Dmin ) \times 100 \qquad ( 1 )$$

### (2) Insulator

### (2-1) About Resin Materials

Insulator 12 may contain one or more types of resin materials selected from a fluororesin and a fluororubber. Insulator 12 contains one or more types of resin materials selected from the fluororesin and the fluororubber, and thus heat resistance can be imparted to heat-resistant electric wire 10.

As the fluororesin, for example, one or more kinds selected from ethylene-tetrafluoroethylene copolymer (E-TFE copolymer), polytetrafluoroethylene (PTFE), tetrafluoroethylene-perfluoroalkyl vinyl ether copolymer (PFA), tetrafluoroethylene-hexafluoropropylene copolymer (FEP), vinylidene fluoride resin (PVDF), and the like can be used.

As the fluororubber, for example, one or more kinds selected from vinylidene fluoride based rubber (FKM), tetrafluoroethylene propylene rubber (FEPM), tetrafluoroethylene-perfluoromethyl vinyl ether rubber (FFKM), tetrafluoroethylene/propylene copolymer (TFE-P copolymer), a mixture of TFE-P copolymer and ethylene-tetrafluoroethylene copolymer (E-TFE copolymer), a mixture of FKM and vinylidene fluoride resin (PVDF), and the like can be used.

Insulator 12 may contain additives such as a filler and a lubricant in addition to the resin material.

The resin material of insulator 12 may be crosslinked or not crosslinked.

### (2-2) About Cavity

### (About Shape of Cavity)

Insulator 12 may include cavity 13.

Insulator 12 may include a fluorine-containing resin, which is fluororesin or fluororubber, as the resin material. Since insulator 12 includes cavity 13, the amount of the fluorine-containing resin used can be reduced.

The shape of cavity 13 of insulator 12 is not particularly limited.

Cavity 13 may have a continuous shape along the longitudinal direction of heat-resistant electric wire 10. Cavity 13 may have a columnar shape in which the central axis of cavity 13 is formed along the longitudinal direction of conductor 11. Although FIG. 1 shows an example in which the cross section of cavity 13 is circular, that is, the cavity 13 has a cylindrical shape, the cross section is not limited to such a shape, and the cross sectional shape of cavity 13 perpendicular to the longitudinal direction of conductor 11 may be a polygonal columnar shape such as a quadrangular shape or a triangular shape. Cavity 13 preferably has a columnar shape because the porosity of insulator 12 and the arrangement of cavity 13 in insulator 12 can be accurately controlled.

It is noted that, the columnar shape of cavity 13 does not have a geometrically strict meaning, and for example, the shape and size of cavity 13 in a cross section perpendicular to the longitudinal direction may vary depending on the location due to an error in the manufacturing process or the like.

### (About Porosity)

The porosity of insulator 12 is not particularly limited, but is preferably 10% to 60%.

By setting the porosity of insulator 12 to 10% or more, the amount of the fluorine-containing resin used can be reduced. In addition, the weight of heat-resistant electric wire 10 can be suppressed, and workability during wiring and handleability during transportation can be enhanced.

By setting the porosity of insulator 12 to 60% or less, the ratio of the resin portion included in insulator 12 can be enhanced, and the voltage endurance characteristics and the elongation tensile-strength of heat-resistant electric wire 10 can be particularly enhanced.

The porosity of insulator 12 is more preferably 40% to 60%.

By setting the porosity of insulator 12 to 40% to 60%, the amount of the fluorine-containing resin can be particularly reduced, the weight of heat-resistant electric wire 10 can be suppressed, and the workability during wiring and the handleability during transportation can be particularly enhanced. In addition, the voltage endurance characteristics and the elongation tensile-strength of heat-resistant electric wire 10 can be enhanced.

The porosity of insulator 12 means an area ratio of cavity 13 in insulator 12 obtained in a randomly selected cross section perpendicular to the longitudinal direction of heat-resistant electric wire 10.

### (2-3) About Method of Manufacturing Insulator

Insulator 12 including cavity 13 shown in FIG. 1 can be manufactured by using, for example, an extruder 30 shown in FIG. 3 in which a die 31 and a point jig 32 are combined.

A columnar members 33 may be provided in point jig 32 in the same number as cavities 13 provided in insulator 12. Columnar member 33 can be formed in a shape corresponding to the shape of cavity 13.

Die 31 has a circular outlet 311, and the resin is extruded from a passage 34 and a passage 35 between point jig 32 and die 31. At this time, the conductor is also pulled out from a center hole 322 of a cylindrical portion 321 of point jig 32. By performing the above operation, the conductor is coated with the extruded resin. At this time, since the resin does not flow in the portion of columnar member 33, a cavity is formed in the resin.

The resin may be coated by a draw-down method in which the resin that has exited from the outlet of die 31 is drawn out to reduce the diameter and coated.

Columnar member 33 may be provided with an air hole 331 to allow air to pass through to the external atmosphere, so that air can be blown into the cavity formed in the resin.

In the above extruder 30, the porosity of the insulator can be easily adjusted by the diameter and number of columnar members 33 provided in point jig 32.

### (2-4) About Configuration of Insulator 12

Insulator 12 may include a solid layer not including cavity 13 in addition to a cavity-included layer 122 including cavity 13.

Insulator 12 may have a first solid layer 121 at a position closer to conductor 11 than cavity-included layer 122, for example, as shown in FIG. 1. A second solid layer 123 may be provided at a position farther from conductor 11 than cavity-included layer 122.

Although only one of first solid layer 121 and second solid layer 123 may be provided, it is preferable to provide both of them from the viewpoint of improving the voltage endurance characteristics and the tensile-strength of heat-resistant electric wire 10.

First solid layer 121, cavity-included layer 122, and second solid layer 123 may have the same configuration except for the presence or absence of cavity 13, and may be formed integrally.

### (3) Outer Diameter of Insulator

Outer diameter D11 of conductor 11 and an outer diameter D12 of insulator 12 are not particularly limited. For example, D11/D12, which is the ratio of outer diameter D11 of conductor 11 to outer diameter D12 of insulator 12, may be set to 0.45 to 0.55.

By setting D11/D12 to 0.55 or less, the thickness of insulator 12 can be sufficiently secured, and the voltage endurance characteristics and the elongation tensile-strength of heat-resistant electric wire 10 can be particularly enhanced.

By setting D11/D12 to be 0.45 or more, insulator 12 can be prevented from being excessively thick, and workability during wiring, handleability during transportation, and the like can be enhanced.

### EXAMPLES

The present invention will be described below with reference to specific examples, but the present invention is not limited to these examples.

### (Evaluation Method)

First, a method of the evaluation of a heat-resistant electric wire produced in the following example will be described.

### (1) Outer Diameter of Conductor, Outer Diameter of Insulator

Outer diameter D11 of conductor 11 and outer diameter D12 of insulator 12 were measured in accordance with JIS C 3005 (2014).

Specifically, the outer diameter of conductor 11 was measured along two diameters orthogonal to each other in a randomly selected cross section perpendicular (right angle) to the longitudinal direction of heat-resistant electric wire 10, and the average value was defined as outer diameter D11 of conductor 11.

Although conductor 11 is described as an example here, outer diameter D12 of insulator 12 was also obtained by the same procedure except that the object to be evaluated was insulator 12.

Further, D11/D12 was calculated from measured outer diameter D11 of conductor 11 and measured outer diameter D12 of insulator 12.

In a heat-resistant electric wire 40 of Example 2, an outer diameter D11C of a conductor 11C, instead of conductor 11, is obtained in the same procedure as outer diameter D11 of conductor 11, and D11C/D12 is calculated.

### (2) Compression Ratio of Conductor

The method of obtaining the compression ratio of the conductor has been described above, and thus the description thereof will be omitted.

### (3) Porosity of Insulator

The area ratio of cavity 13 to insulator 12, which was obtained in a randomly selected cross section perpendicular to the longitudinal direction of the heat-resistant electric wire was defined as the porosity of insulator 12.

### (4) Voltage Endurance Test

In the voltage endurance test, an evaluation test was performed in accordance with JIS C 3005 (2014). The evaluation was performed by placing a heat-resistant electric wire in water. Samples with 1000 VAC/1 min or more were evaluated as A, and samples with 1000 VAC/1 min or less were evaluated as B.

When the evaluation is A, it means that the heat-resistant electric wire has excellent voltage endurance characteristics, and when the evaluation is B, it means that the voltage endurance characteristics are not sufficient.

### (5) Elongation Tensile-Strength

The elongation tensile-strength was evaluated for portion of insulator 12 of the heat-resistant electric wire produced in the example, from which conductor 11 was removed.

The elongation tensile-strength (%) of the sample to be evaluated was measured and calculated by performing a tensile test at distance between markings of 25 mm and a tensile speed of 50 mm/min.

The elongation tensile-strength & can be calculated by the following formula (2).

$$ε = ( L 1 - L 0 ) / L 0 \times 100 \qquad ( 2 )$$

The L1 in formula (2) is the distance between markings at break and the L0 is the distance between markings (25 mm) before the start of the test.

The case when the elongation tensile-strength & was 100% or more was evaluated as A, and the case of less than 100% was evaluated as B.

When the evaluation is A, it means that the heat-resistant electric wire has sufficient elongation tensile-strength, and when the evaluation is B, it means that the heat-resistant electric wire has insufficient elongation tensile-strength.

The heat-resistant electric wire in each example will be described below.

Example 1 is an example, and Example 2 is a comparative example.

### Example 1

Heat-resistant electric wire 10 having a cross-sectional shape shown in FIG. 1 was produced and evaluated.

As conductor 11, a stranded wire was prepared by stranding 12 conductor element wires 111, which are soft copper wires. A compressed conductor obtained by compressing the stranded wire from the outer surface was used as conductor 11. The compression ratio of conductor 11 was 52%.

Insulator 12 includes first solid layer 121 and second solid layer 123 in addition to cavity-included layer 122 including cavity 13.

Insulator 12 was manufactured by using extruder 30 in which die 31 and point jig 32 shown in FIG. 3 were combined, and was manufactured by extruding and drawing down fluororubber. As the fluororubber, tetrafluoroethylene propylene rubber (FEPM) was used.

Insulator 12 was provided with columnar cavity 13 continuously extending along the longitudinal direction of heat-resistant electric wire 10, and the porosity was 40%. Further, the ratio D11/D12 of outer diameter D11 of conductor 11 to outer diameter D12 of insulator 12 was 0.47.

The evaluation results are shown in Table 1.

### Example 2

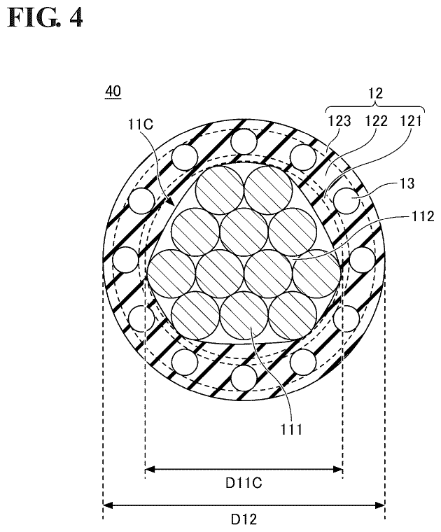

Heat-resistant electric wire 40 having a cross-sectional shape shown in FIG. 4 was produced and evaluated.

Heat-resistant electric wire 40 shown in FIG. 4 uses uncompressed conductor 11C instead of conductor 11 which is a compressed conductor. Except for the above, a heat-resistant electric wire was produced under the same conditions as in Example 1.

The evaluation results are shown in Table 1.

TABLE 1

| | EXAMPLE 1 | EXAMPLE 2 |
|---|---|---|
| COMPRESSION RATIO [%] | 52 | 0 |
| VOLTAGE ENDURANCE TEST | A | B |
| ELONGATION TENSILE-STRENGTH | A | B |

What is claimed is:

1. A heat-resistant electric wire comprising:
a conductor; and
an insulator configured to cover the conductor,
wherein a ratio of an outer diameter of the conductor to an outer diameter of the insulator is 0.45 to 0.55,
wherein the conductor is a compressed conductor in which a stranded wire including a plurality of conductor element wires is compressed, the plurality of conductor element wires being twisted together,
wherein the insulator contains one or more types of resin materials selected from a fluororesin and a fluororubber and includes a cavity, and
wherein porosity of the insulator is 10% to 60%.

2. The heat-resistant electric wire according to claim 1,
wherein the porosity of the insulator is 40% to 60%.
